(19) United States
(12) Patent Application Publication
(10) Pub. No.: US 2024/0180199 A1
(43) Pub. Date: Jun. 6, 2024

(54) IMPROVED ENRICHMENT OF VITAMIN D3 IN TRANSFORMED COLEOPTERAN LARVAE BY A METHOD OF ULTRAVIOLET TREATMENT AND ASSOCIATED FOOD POWDER

(71) Applicant: NUTRI'EARTH, Lomme (FR)

(72) Inventors: Jérémy DEFRIZE, Hallennes les Haubourdin (FR); Thomas DORMIGNY, Meurchin (FR); Charles-Antoine DESTAILLEUR, Sailly-sur-La-Lys (FR)

(21) Appl. No.: 18/576,229

(22) PCT Filed: Jun. 15, 2022
(86) PCT No.: PCT/FR2022/051151

§ 371 Date: Jan. 3, 2024

(30) Foreign Application Priority Data
Jul. 8, 2021 (FR) FR2107438

(51) Int. Cl. A23K 10/20; A23K 20/174; A23K 30/20; A23L 5/30

(52) U.S. Cl. CPC A23K 10/20; A23K 20/174; A23K 30/20; A23L 5/30

(57) ABSTRACT

The present invention relates to a method for preparing a beetle powder comprising a light treatment step during which at least one light source emits ultraviolet rays of the UVB type in the direction of processed beetle larvae. The ultraviolet rays of the UVB type having an irradiance at the powder greater than 80 μW/cm².

### TECHNICAL FIELD

The present invention relates to the field of the food industry.

The object of the present invention relates more precisely to the preparation of a food powder containing beetles.

One of the objects of the present invention is to improve the enrichment with vitamin D3 of a powder coming from beetle larvae.

The present invention thus has numerous uses in particular in the food industry, and in particular for human food, reptile food, animal food (PetFood/PetCare/Dietary supplement) or fish farming.

### PRIOR ART

Vitamin D3 has properties important for the body.

Vitamin D3 means cholecalciferol here.

In humans, this vitamin D3 participates in particular in maintaining normal blood levels of calcium and of phosphorus absorbed by the intestine. It strengthens the immune system and improves cognitive function.

Vitamin D3 also plays an essential role in the maintenance of bones and skeletal muscles in humans and pets such as dogs.

It is for example used in addition to calcium to prevent osteoporosis in elderly people.

In reptiles, vitamin D3 allows an optimal assimilation of calcium and the mineralization of the bones.

It is known today that 50% of adults in good health suffer from a vitamin D3 deficiency.

The daily requirements for vitamin D3 are 15 μg for adults and can rise to 20 μg in people over 70 years old.

Conventionally, the food sources containing vitamin D3 come substantially from fish through in particular the oils, the fillet or the livers of fish. However, fish are a declining resource, which is therefore becoming more and more expensive.

Vitamin D3 extracted from boreal lichen or synthesized from lanolin can also be found in the form of supplements.

The foods rich in vitamin D3 are thus present in a reduced quantity; as for the demand for vitamin D3, it is strongly increasing.

The players in the food industry thus concentrate a lot of energy on finding solutions allowing to manufacture this vitamin D3 in a sustainable and reasoned manner.

The document WO2019229332 A1 belonging to the applicant is known from the prior art.

This document proposes a manufacturing of food powder rich in vitamin D3 containing beetles.

In this document, an ultraviolet treatment, called UV treatment, during the growth phase of larvae of the type Tenebrio molitor or Alphitobius diaperinus is more particularly proposed. Such a UV treatment during the growth phase of the larvae allows a significant synthesis of vitamin D3.

Indeed, the results obtained with the enrichment technology proposed in the document WO2019229332 A1 reveal that without UV treatment, the larvae contain little or no vitamin D3 (between 0 and 2 μg/100 g of dry weight), whereas with a UV treatment during the growth phase of the larvae, an average maximum concentration of vitamin D3 in the larva of approximately 50 μg/100 g of dry weight is obtained on average. These live larvae rich in vitamin D3 then allow after the processing phase to obtain beetle powders or beetle larvae rich in vitamin D3.

The applicant contends, however, that on the industrial level, the implementation of the solution proposed in the document WO2019229332 A1 remains complex.

Indeed, according to the technical teaching of this document, the UV treatment is carried out directly on live larvae during their larval growth phase.

This engenders several issues that can greatly harm the productivity of a farm and make the industrialization of the UV treatment method difficult.

The applicant contends first of all that a UV treatment on live larvae can engender a rate of mortality of the larvae ten times greater than that observed with larvae in the absence of a UV treatment in particular when the light source is placed at a distance of less than 25 centimeters from the live larvae.

Indeed, tests show that the mortality rate of larvae 12 weeks old having undergone a UV treatment (25 W lamp, index UVB 200) for 10 days at a distance of 25 centimeters from the light source is 0.1% whereas it is 0.01% without this light treatment.

The applicant contends secondly that the surface area necessary to carry out this type of UV treatment is significant.

To obtain a synthesis of vitamin D3 of 50 ug/100 g of dry weight of larvae, a 25W UVB lamp (Index UVB 200) must be placed at a distance of 25 centimeters from the tank containing the larvae for 10 days. These tanks have a dimension of 56 centimeters×38 centimeters×17 centimeters. This configuration allows to minimize the mortality rate while maximizing the rate of synthesis of vitamin D3.

It is therefore very costly in terms of time but also in terms of surface area since in the conditions described above, a structure of 125 centimeters×200 centimeters×30 centimeters allows to produce only 10.5 kilograms of live larvae (or 3.75 kilograms of powders) every 10 days. The applicant thus contends that the solutions of the prior art are not to date entirely satisfactory for an industrialization of the manufacturing of a food beetle powder rich in vitamin D3. It would indeed be of interest to find a reliable industrial solution allowing to significantly increase the concentration of vitamin D3 in the processed beetle larvae while reducing the manufacturing costs.

### OBJECT OF THE INVENTION

The present invention aims to improve the situation described above.

The present invention aims more particularly to overcome the various disadvantages mentioned above by proposing an efficient solution easy to implement on the industrial level for significantly increasing the concentration of vitamin D3 in a beetle powder, while limiting the industrial costs.

The object of the present invention relates according to a first aspect to a method for preparing a beetle powder enriched with vitamin D3 comprising a light treatment step during which at least one light source emits ultraviolet rays of the UVB type in the direction of processed beetle larvae. According to the invention, the ultraviolet rays of the UVB type have an irradiance at the powder greater than 80 μW/cm².

By emitting such UVB rays with an irradiance greater than 80 μW/cm², it was observed that it was possible to significantly reduce the period of UV treatment and to obtain a surprising increase in the concentration of vitamin D3.

This reduction in the duration of exposition allows to optimize the process, to reduce the costs thereof and to facilitate the industrialization thereof.

Preferably, the irradiance of the UVB rays emitted is between 80 and 1,000 μW/cm².

Preferably, the irradiance of the UVB rays emitted is between 150 and 250 μW/cm².

Preferably, the irradiance of the UVB rays emitted is between 170 and 200μW/cm².

### UV Pretreatment Steps (the Processing):

Here, processed larvae means beetle larvae that have undergone at least a slaughtering process. Advantageously, the method according to the present invention comprises, before the light treatment step, a step of processing the beetle larvae comprising a slaughtering of said larvae. Preferably, the processing step is carried out on beetles in the larval phase.

According to a first alternative, this slaughter is carried out by a cold thermal treatment. than 4° C. for a duration greater than 10 minutes.

According to a second alternative, this processing step is carried out by a hot thermal treatment. Hot thermal treatment means for example an exposure of the beetle larvae to temperatures greater than 40° C. for a duration greater than 15 seconds in water (scalding) or greater than 30 minutes with heated air.

In a specific embodiment, it is possible, during the slaughtering step, for the larvae to be positioned in a water having a temperature of between 50 and 120° C., preferably between 85° C. and 110° C., even more preferably between 90° C. and 100° C.

This is also called scalding.

Such a technique of slaughtering by scalding turns out to be efficient and allows to preserve the nutritional properties of the beetles and to reduce the bacterial load of the larvae.

Preferably, this scalding is carried out for a scalding duration of between 30 seconds and 10 minutes, preferably between 1 and 5 minutes.

According to a third alternative, the slaughtering step can also be carried out by an exposure of the beetle larvae to microwaves for example for at least 10 seconds.

Advantageously, the processing phase comprises after slaughter a dehydration (or cooking) step aiming to obtain an activity of water of the powder of <0.7.

For this dehydration, it is possible to provide a microwave treatment.

Microwave treatment means the exposure of the beetle larvae to microwaves for example for at least 10 seconds.

For this dehydration, it is also possible to provide alternatively or in addition a thermal treatment of the slaughtered larvae.

During this thermal treatment of the larvae for dehydration, the slaughtered larvae are thus placed in an environment of between 40 and 250° C., preferably between 50 and 150° C., preferably for a treatment duration of between 1 hour and 24 hours, so that the slaughtered larvae have:
between 2 and 15% water, more preferably between 3 and 8% water, and/or
an activity of water (AW) of less than 0.7.

Preferably, during the thermal treatment, the processed larvae are disposed over a thickness of between 1 and 100 millimeters, preferably between 5 and 15 millimeters.

Optionally, the processed larvae can undergo a grinding and/or a pressing.

Preferably, the processing step comprises, after slaughter, a grinding of the larvae to obtain a beetle powder.

It is noted here that the grinding of the larvae after dehydration allows to improve the performance of synthesis of vitamin D3 after UV treatment. This step after dehydration remains optional, however.

After dehydration and grinding a beetle powder is obtained.

Beetle powder means a dry powder (AW<0.7) consisting for example:
either of whole larvae of Tenebrio molitor having undergone a drying thermal process and a grinding;
   or of whole larvae of Alphitobius diaperinus having undergone a drying thermal process and a grinding;
   or of a mixture of larvae of these two species having undergone a drying thermal process and a grinding;
   or of a fraction of whole larvae of Tenebrio molitor having previously undergone a pressing process then a drying thermal process and a grinding;
   or of a fraction of whole larvae of Alphitobius diaperinus having previously undergone a pressing process then a drying thermal process and a grinding;
or of a mixture of a fraction of larvae of these two species having previously undergone a pressing process then a drying thermal process and a grinding.

In a specific embodiment, the processing step comprises a first screening of the larvae to eliminate the residues like excrement or possible remains of food.

Such a screening remains optional, however. It has the simple goal of cleaning the larvae before slaughter.

Preferably, the processing step comprises a fasting for 24 to 48 hours. Such a fasting avoids the appearance of new excrement. Such a fasting thus remains optional to implement in the context of the present invention.

Optionally, the fasting step is followed by a second screening.

Advantageously, the processing step comprises before the slaughter a stunning with cold between −18° C. and +4° C.

Preferably, the step of stunning with cold is implemented for a stunning duration of between 1 and 5 minutes. The slaughter can be carried out without stunning; such a stunning thus remains optional to implement in the context of the present invention.

### Steps of the UV Treatment (Synthesis of the Vitamin D3):

Advantageously, the ultraviolet rays emitted by the at least one light source in the direction of the processed beetle larvae during the light treatment step are:
of the UVB type and consist of electromagnetic radiation, the wavelength of which is between 280 nm and 320 nm, and/or;
of the UVA type and consist of electromagnetic radiation, the wavelength of which is between 320 nm and 400 nm.

Preferably, it is intended, during the light treatment step, for the at least one light source to be positioned at a determined distance from the beetle larvae of between approximately 1 and 100 centimeters, preferably between approximately 5 and 20 centimeters.

The intensity of the UV light sources decreases as the latter is moved away from. The quantity of vitamin D3 synthesized depends on the quantity of UVB received per unit of time.

Advantageously, the at least one light source has a radiating power of between 13 and 125 watts, preferably between 20 and 50 watts.

Advantageously, it is intended, during the light treatment step, for the at least one light source to emit the ultraviolet rays in the direction of the processed beetle larvae according to a treatment range of between 10 seconds and 24 hours, preferably between 1 and 7 minutes, preferably between 2 and 5 minutes.

Advantageously, this treatment range is achieved continuously or cumulatively. It is understood here that a UV treatment of 3 minutes can be carried out for example over 3 minutes continuously or according to 3 successive periods of 1 minute each spaced apart for example by rest periods of several minutes. Advantageously, it is intended, during all or a part of the light treatment step, for the processed beetle larvae to be maintained in an environment having a substantially constant temperature of between 15 and 35° C., preferably between 22 and 26° C.

The synthesis of vitamin D3 is optimized in the presence of a temperature greater than 20° C.

The object of the present invention relates according to a second aspect to a beetle powder obtained by implementing the preparation method as described above.

The object of the present invention relates according to a third aspect to a use of a beetle powder as described above for human or animal food.

Preferably, the powder is used as an ingredient or dietary supplement.

Other advantageous uses could be possible for example such as food for reptiles or that for fish.

### DRAWINGS

Other features and advantages of the present invention will be clear from the description below, in reference to the appended FIGS. 1 to 4A-4D which illustrate an exemplary embodiment thereof devoid of any limiting nature and in which:

FIG. 1 is a graph showing the vitamin D3 concentration of several samples of beetle larvae having undergone a UV light treatment with a duration of exposure of eight hours;

FIG. 2 is a graph showing the change in the vitamin D3 concentration of several samples of beetle larvae having undergone a UV light treatment as a function of time;

FIG. 3 is a graph showing the change over time in the vitamin D3 concentration for several different samples of beetle powder subjected to UV sources having a specific UVB irradiance;

FIG. 4A comprises a graph illustrating a first exemplary embodiment of the change in an oxidation indicator of the beetle powder as a function of the duration of UVB treatment and of the level of UVB irradiance;

FIG. 4B comprises a graph illustrating a second exemplary embodiment of the change in an oxidation indicator of the beetle powder as a function of the duration of UVB treatment and of the level of UVB irradiance;

FIG. 4C comprises a graph illustrating a third exemplary embodiment of the change in an oxidation indicator of the beetle powder as a function of the duration of UVB treatment and of the level of UVB irradiance;

FIG. 4D comprises a graph illustrating a fourth exemplary embodiment of the change in an oxidation indicator of the beetle powder as a function of the duration of UVB treatment and of the level of UVB irradiance.

### DETAILED DESCRIPTION

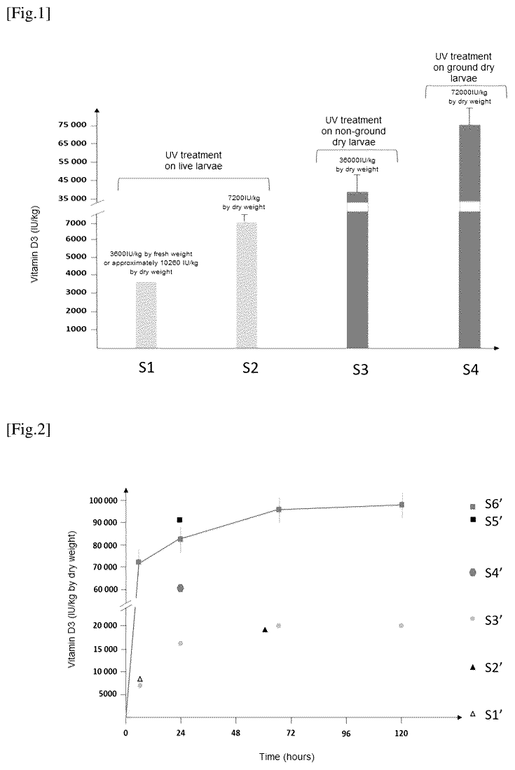

An exemplary embodiment of a preparation of a beetle powder rich in vitamin D3 will now be described below in reference jointly to FIGS. 1 to 4A-4D.

As a reminder, the powder preparation that will be described here aims to develop a technique to significantly increase the concentration of vitamin D3 in the powders containing beetles, and in particular the beetles of the Tenebrio molitor and/or Alphitobius diaperinus type. Contrary to the techniques providing a UV treatment on live beetles (for example fresh beetle larvae) as proposed in the document WO2019229332, one of the underlying concepts of the present invention is to carry out a UV treatment consisting in emitting onto processed larvae UVB rays having an irradiance greater than 80 μW/cm².

Here, processed larvae means beetle larvae having undergone at least a slaughter.

In the example described here and used in the various experiments, larvae selected from the following species are used: Tenebrio molitor and/or Alphitobius diaperinus.

It is understood that other experiments not described here were carried out with other species and show equivalent results.

It is noted here that the growth phase of the larvae is not described in this present document since the invention relates to the UV treatment (and incidentally to the processing phase), the phases before the farming are not part of the present invention.

### Processing Phase

In a specific embodiment of the present invention, the processing phase is carried out in the following manner.

Between the 6th and the 14th week of growth, more preferably between the 10th and the 13th week of growth, the larvae are screened to eliminate the excrement.

The screened larvae are then placed in a plastic tank for a fast of 24 to 48 hours.

After the fast, the larvae are again screened to remove the excrement.

The larvae are placed in water between 85° C. and 100° C. for slaughter between 1 to 4 minutes. This is called hot thermal slaughter.

During this processing, just before the slaughter, a step of stunning with cold between −18° C. and +4° C. for several minutes is further provided.

After the slaughter, the larvae undergo a thermal treatment at a temperature of between 50 and 150° C. for a duration of between 1 hour and 24 hours according to the temperature used. The larvae obtained contain between 2 and 15% water, more preferably between 3 and 8% water and an activity of water of less than 0.9, more preferably less than 0.7.

A grinding phase can be carried out. The term powder includes here any reduction into an element of less than 3 millimeters of the whole insects having undergone a previous thermal treatment in their larval or nymph stage or only of a morphological part of these insects. It is understood here that this is a description of a specific embodiment of this processing phase. Such an embodiment allows to obtain results with good performance. It is understood however that a person skilled in the art can envisage other embodiments for processing the beetle larvae. It is also noted here that the manufacturers of powder will not necessarily implement this slaughter phase and that they can buy from a supplier, a beetle farmer, who will deliver to them beetle larvae already processed (or slaughtered). In this case, the powder manufacturer will directly carry out the phase of enrichment (or UV treatment) to enrich the powder with vitamin D3.

For these reasons, it is understood that the examples of processing given above are purely illustrative and are not an integral part of the invention.

### 1^{st} SERIES OF TESTS

### UV Treatment Phase

In this example processed larvae are available.

In this example, these processed larvae are in the form of dehydrated larvae ground into powder or non-ground dehydrated whole larvae.

In this example, it is intended to apply to these processed larvae a UV treatment which is characteristic of the present invention.

In this example, this UV treatment step is carried out in a specific room.

In the exemplary embodiment of the present invention, this room is maintained in ambient conditions allowing to maintain the processed beetles in an environment having:
a substantially constant temperature of between 15 and 35° C., preferably between 22 and 26° C.; and
a substantially constant humidity of between 20 and 80% relative humidity, preferably between 30 and 40%.

This controlled management of the ambient parameters (temperature and humidity) allows to obtain a better yield in the synthesis of the vitamin D3.

A person skilled in the art could however envisage other similar ambient conditions.

In this example, the UV treatment lasts between 2 minutes and 72 hours in a continuous manner.

It is noted that it is possible to further reduce this treatment period.

In the example described here, it is thus sought to enrich processed beetle larvae with vitamin D3 by a UV treatment.

Such a UV treatment implements at least one light source of the ultraviolet source type (or UV source) that emits ultraviolet rays in the direction of the processed beetle larvae.

Preferably, the UV source is maintained in position vertically above the beetle powder or the whole beetles.

In this example, the ultraviolet rays emitted by the UV source in the direction of the beetle larvae are:
of the UVB type and consist of electromagnetic radiation, the wavelength of which is between 280 nm and 320 nm, and/or
of the UVA type and consist of electromagnetic radiation, the wavelength of which is between 320 nm and 400 nm.

It is noted here that the emission of light in the visible range has no incidence on the synthesis of the vitamin D3.

In the example described here, the UV source is positioned, during the light treatment phase, at a determined distance from the beetle larvae of between approximately 2 and 100 cm, preferably between 10 and 30 cm.

In this example, the UV source has a radiating power of between 13 and 125 watts, preferably between 20 and 50 watts.

In this first example, the UVB rays emitted by the UV source have an irradiance equal to approximately 75 μW/cm².

Optionally, after this UV phase, a second thermal treatment of between 40 and 200° C., preferably between 60 and 100° C. for 1 hour to 24 hours can be carried out.

### Results

Initial results obtained in the context of the various studies and tests carried out are of particular interest:

TABLE 1
Results: Document

| WO2019229332 A1 | Results | |
|---|---|---|
| Vitamin D3 concentration | Vitamin D3 concentration | Vitamin D3 concentration |
| after UV treatment on live | after UV treatment on | after UV treatment on |
| larvae for 5 days. ¹ | processed larvae not reduced | processed larvae reduced |
| | to a powder for 5 days. ¹ | to a powder for 5 days. ¹ |
| 24 μg/100 g of dry | 97 μg/100 g of dry | 204 μg/100 g of dry |
| weight (=9,600 IU/kg) | weight (=38,800 IU/kg) | weight (=81,600 IU/kg) |

¹ The live larvae and the processed larvae are located 25 cm from the light source and placed in tanks having dimensions of 57 centimeters × 38 centimeters × 17 centimeters. The thickness of the live and processed larvae is 1 cm maximum.

These results are confirmed and amplified by other series of tests that will be described in detail in the rest of the description. These additional tests and analyses (FIGS. 1 & 2) on the concentration of vitamin D3 show that this 1^{st} series of tests allows to increase up to ten times the synthesis of vitamin D3 with respect to the method described in the document WO2019229332 A1.

### Increasing the Production by 2.5 per Unit of Surface Area

The present invention also allows to increase the production of processed larvae per unit of surface area.

As a reminder: in the document WO2019229332 A1, the light sources for the UV treatment on the live larvae are preferably positioned above the tanks containing the larvae at an optimal distance of between 25 and 35 centimeters to avoid too great a mortality rate related in particular to the excessive heat.

Via the present invention, the light source can be placed between 10 and 15 centimeters without any impact on the mortality.

In the document WO2019229332 A1, a structure having dimensions of 125 centimeters×200 centimeters×30 centimeters housing the light sources and the tanks containing the live larvae over a period of 5 days allows to produce 10.5 kg of live larvae, or 3.75 kilograms of larvae powder, containing 24 μg/100 g vitamin D3 by dry weight. With the present invention, the same structure over an equivalent period allows to produce 9.5 kg of larvae powder containing, according to the duration of exposure, between 50 and 500 μg/100 g vitamin D3 by dry weight, or 2.5 times more. This is possible by the reduction of the distance between the light sources and the processed larvae but also because it is possible to work directly on the processed larvae having previously undergone a thermal treatment. Said larvae will no longer lose weight contrary to the live larvae which must undergo cooking or dehydration and which lose 65% of their total mass by the evaporation of the water.

### Reducing by 100 the Time of the Light Treatment

According to the technique proposed in the document WO2019229332 A1, it took 10 days of light treatment to reach 50 μg/100 g of vitamin by dry weight in the larva.

After this 1^{st} series of tests, a concentration of 50 μg/100 g of dry weight is obtained in 1 to 2 hours of UV treatment.

These results are highlighted in the second series of tests described in detail below.

The analyses of quantification of the vitamin D3 were carried out by a Cofrac-certified independent laboratory. The quantification is carried out by semi-preparative HPLC followed by reversed-phase HPLC with a UV/DAD detector (265 nm).

Other tests were also carried out to highlight and optimize the advantageous effects of the post-processing UV treatment of the larvae.

### 2^{nd} SERIES OF TESTS

During this second series of tests, several samples S1, S2, S3 and S4 of larvae of the Tenebrio molitor type are available. Each sample has differences (larvae that are fresh, live, etc.).

These analyses were carried out by a Cofrac-certified independent laboratory according to the standard EN 12821: 2009-08.

During these tests, a UV treatment is applied to each of these samples S1, S2, S3 and S4 and their concentration of vitamin D3 is measured.

The results and analyses of these tests on the samples S1 to S4 are illustrated in FIG. 1; this FIG. 1 shows more particularly the concentration of vitamin D3 for each of the samples S1, S2, S3 and S4 after 8 hours of exposure.

The first test (sample S1) relates to a UV treatment on live larvae of Tenebrio molitor.

In this first test, a UV treatment on these live larvae as proposed in the document WO2019229332 A1 is provided. The only difference is that here, the concentration of vitamin D3 is quantified directly on previously frozen fresh larvae.

In this first example, the distance of the UV lamp above the live larvae is 20 cm with the following characteristics of the light bulb: 25 W; 10% UVB, Exo Terra; average irradiance: 74.1 μW/cm²; average temperature: 31.8° C.

According to FIG. 1, this concentration is 3,600 IU/kg by fresh weight, or approximately 10,260 IU/kg by dry weight; this conversion into concentration in dry larvae was obtained by multiplying the concentration in fresh larvae by 2.85 (the larvae of Tenebrio molitor contain on average 65% water).

Here, IU is an international unit: 1 IU=0.025 μg of vitamin D3.

The second test (sample S2) also relates to a UV treatment on live larvae.

In this second test, a UV treatment on these larvae is thus provided.

Here, the distance of the lamp above the sample of larvae S2 is 20 cm with the following characteristics of the light bulb: 25 W; 10% UVB, Exo Terra; average irradiance: 75 μW/cm²; average temperature: 29.44° C.

These fresh larvae are then processed according to the technique proposed in the document WO2019229332 A1 to obtain a powder of dry larvae enriched with vitamin D3 by a UV treatment during the larval phase.

The concentration of vitamin D3 is measured here on the dehydrated dry larvae.

According to FIG. 1, the concentration of vitamin D3 for this sample S2 is 7,200 IU/kg by dry weight.

Another test (sample S3) relates to a UV treatment on processed (dead) larvae, and more particularly non-ground dry larvae.

It is understood in this test that the larvae were previously slaughtered and that a UV treatment as proposed according to the present invention is then applied.

This test thus corresponds to a specific exemplary embodiment of the present invention.

It is noted that, in this example, the slaughter is carried out by soaking in a bath of water at 100° C. for 2 minutes. Other techniques are however possible for a person skilled in the art. In this example, the processed larvae were dehydrated at 65° C. for 14 hours.

The processed (but not ground) larvae are then positioned under a lamp positioned at a distance above the non-ground dry larvae of 20 cm; the lamp used has the following characteristics of the light bulb: 25 W; 10% UVB, Exo Terra; average irradiance: 75 μW/cm²; average temperature: 30° C.

According to FIG. 1, the concentration of vitamin D3 for this sample S3 reaches this time 36,000 IU/kg by dry weight, or here five times more that the concentration of vitamin D3 for live larvae (samples S2 and S1).

As for the fourth test (sample S4), it relates to a UV treatment on processed larvae, and more particularly a sample of ground dry larvae.

In this example, it is understood that the larvae of Tenebrio molitor underwent the same slaughtering process as the larvae of the sample S3.

After slaughter, the latter were moreover ground.

In this example, a UV treatment like the invention proposes is thus applied to this sample S4 after slaughter.

The same device as that above is used here, namely a UV lamp positioned at a distance above the ground dry larvae of 20 cm with the following characteristics of the light bulb: 25 W; 10% UVB, Exo Terra. Average irradiance: 75 μW/cm². Average temperature: 30° C.

According to FIG. 1, the concentration of vitamin D3 for this sample S4 reaches this time 72,000 IU/kg by dry weight, or here ten times more than the concentration of vitamin D3 for the live larvae (samples S1 and S2) and two times more than the concentration of vitamin D3 for the sample S3.

This second series of tests highlights the interest of a UV treatment on processed larvae (after slaughter) (sample S3 and S4), and not live larvae as proposed in the document WO2019229332 A1 (sample S1 and S2).

The applicant contends here that faced with a UVB exposure, it could have been thought before the present invention and the above tests that the processed beetle larvae would have at best kept a capacity for synthesis of vitamin D3 identical to that of the live larvae.

It could have even been expected that this capacity to synthesize vitamin D3 be altered because of the processing undergone by the larvae.

However, in a very surprising and unexpected manner, the results obtained show the contrary and reveal that an exposure to UVBs on processed larvae leads to a more powerful synthesis of vitamin D3 with concentrations of vitamin D3 that are five to six times greater than the concentrations obtained after a UVB exposure on live larvae under similar durations and conditions of exposure.

These results which were not expected have a strong impact on the possible yields per unit of surface area and thus on the pertinence of industrializing this method on processed larvae. This series of test also highlights the interest of grinding the processed larvae before the UV treatment, which further multiplies by two the concentration of vitamin D3.

### 3^{rd} SERIES OF TESTS

A third series of tests was carried out to reveal the change in the concentration of the vitamin D3 as a function of the time of UV-B exposure.

During these tests, several samples of larvae of the Tenebrio molitor type, noted here as S1′, S2′, S3′, S4′, S5′ and S6′, are available. These samples are subjected to various tests.

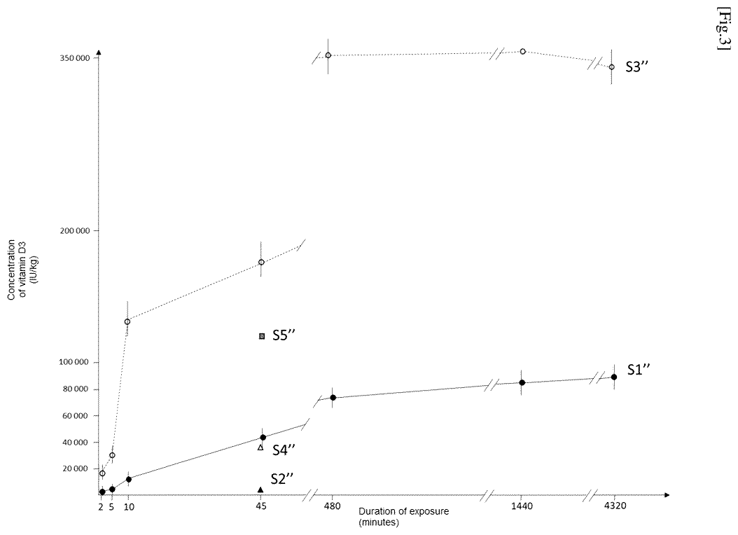

The results and analyses of these various tests on the samples are illustrated in FIG. 2. The analyses were carried out by a Cofrac-certified independent laboratory according to the standard EN 12821: 2009-08.

In this second series of tests, a sample S1′ corresponding to defatted beetle powder is available. Here, defatted powder of Tenebrio molitor is available to which a UV treatment is applied via a UV lamp positioned at a distance above the larvae S1′ of 20 cm. The UV lamp has the following light bulb characteristics: 25 W; 10% UVB, Exo Terra; average irradiance: 75 ηW/cm²; average temperature: 30° C.

In this example, an extraction of the oily fraction of the larvae is then carried out by a pressing of the dry larvae having previously undergone a blanching of 2 minutes at 100° C. then a dehydration of 12 hours at 65° C.

According to FIG. 2, after an exposure to the UV rays of 10 hours, the concentration of vitamin D3 in the sample S1′ is between 5,000 and 10,000 IU/kg of vitamin D3.

During this second series of tests, the sample S2′ comprises here live larvae. A UV treatment is then applied to the live larvae during their growth by a lamp, the light bulb of which has the following characteristics: 25 W; 10% UVB, Exo Terra; average irradiance: 74.1 μW/cm²; average temperature: 31.8° C. Like for sample S1 of FIG. 1, the analysis of the concentration of vitamin D3 is carried out on frozen larvae.

According to FIG. 2, the concentration of vitamin D3 in the sample S2′ is between 15,000 and 20,000 IU/kg of vitamin D3 after an exposure of 60 hours.

The sample S3′ corresponds to groups of live larvae to which a UV treatment is applied during the growth phase. The conditions of exposure are identical to those of S1′ and S2′. With an equal duration of exposure, according to FIG. 2 results substantially identical to those obtained for the sample S2′ are obtained. Like for the sample S2 of FIG. 1, the analysis of the concentration of vitamin D3 is carried out on dehydrated larvae reduced to a powder.

The tests carried out on the samples S1′, S2′ and S3′ correspond to exemplary embodiments of the document WO2019229332A1, that is to say a UV treatment on live larvae.

The sample S4′ corresponds to whole dry larvae (slaughtered). Before UV treatment, these larvae were processed by slaughtering (scalding for 2 minutes at 100° C.) then dehydrated. These larvae remain non-ground however.

A UV treatment is then applied during this test to this sample S4′ by a lamp, the light bulb of which has the following characteristics: 25 W; 10% UVB, Exo Terra; average irradiance: 75 μW/cm²; average temperature: 29.44° C.

Despite the fact that the slaughtered larvae are not ground, it is noted according to FIG. 2 that the concentration of vitamin D3 is high and exceeds 60,000 IU/kg of vitamin D3 after a UV-B exposure of 24 hours.

Finally, in this second series of tests, samples S5′ and S6′ comprising ground dry larvae are available.

The sample S5′ correspond to larvae that were slaughtered by cold at −18° C. before being blanched for 2 min at 100° C., then dehydrated at 65° C.for 14 hours and finally ground. The sample S6′ correspond to larvae that were slaughtered by scalding at 100° C. for 2 minutes, then dehydrated at 65° C. for 14 hours and finally ground. Each point of the samples S6′ comprises 2 distinct analyses (N=2; Average±standard deviation).

For these samples S5′ and S6′, a UV lamp is disposed at a distance above the live larvae of 20 cm. Like for S4′, this UV lamp has the following light bulb characteristics: 25 W; 10% UVB, Exo Terra; average irradiance: 75 μW/cm²; average temperature: 29.44° C.

According to FIG. 2, the concentration of the sample S5′ is between 90,000 and 100,000 IU/kg of vitamin D3 after an exposure of 24 hours.

Still, according to FIG. 2, the concentration of the samples S6′ is between 80,000 and 90,000 IU/kg of vitamin D3 after an exposure of 24 hours. This concentration then exceeds 90,000 IU/kg of vitamin D3 after an exposure of 72 hours.

This third series of tests on the concentration of vitamin D3 shows that the present invention allows to increase, over a given exposure time, by four to ten times the synthesis of vitamin D3 with respect to the method described in the document WO2019229332 A1.

This third series of tests also shows that the grinding allows to maximize the synthesis of vitamin D3, but that on the contrary without grinding the results obtained remain highly appreciated.

### 4^{th} SERIES OF TESTS

In the examples described above (FIGS. 1 and 2), the average irradiance of the UVB rays emitted is 75 μW/cm².

The experiments that will follow in the context of this 4^{th} series of tests aim to vary the irradiance of the UVB rays to highlight the influence of this irradiance on the performance of the synthesis of vitamin D3.

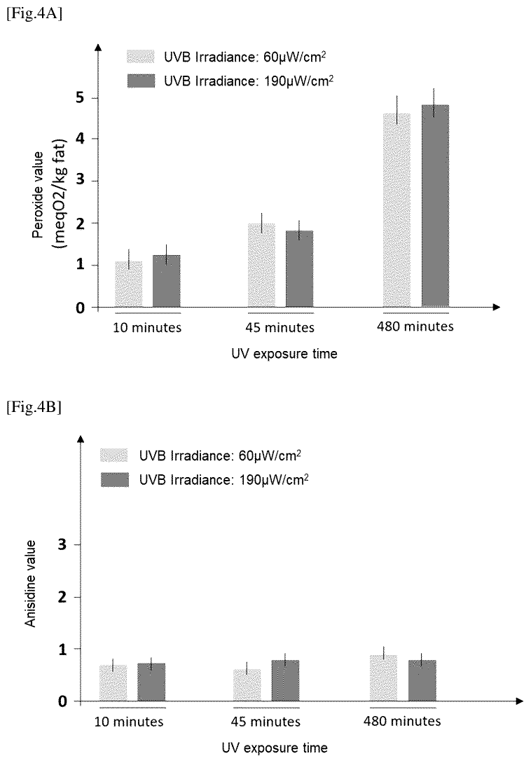

FIG. 3 shows the change over time in the concentration of vitamin D3 in four samples of beetle powder, respectively noted as S1″, S2″, S3″ and S4″, which are each subjected to a UV treatment with light sources having different irradiances.

In this example, the samples S1″ (black circles; N=2 for each duration; average±sd) correspond to a powder of Tenebrio molitor subjected to a UV treatment by a UV source having a UVB intensity (irradiance) of 60 μW/cm² at the powder.

In this example, the sample S2″ (black triangle; N=2; average±sd) corresponds to a powder of Alphitobius diaperinus subjected to a UV treatment by a UV source having a UVB intensity (irradiance) of 60 μW/cm² at the powder for 45 minutes.

The samples S3″ (white circles; N=2 for each duration; average±sd) correspond to a powder of Tenebrio molitor subjected to a UV treatment by a UV source having a UVB intensity (irradiance) of 190 μW/cm² at the powder.

As for the fourth sample S4″ (white triangle; N=2; average±sd), it corresponds to a powder of Alphitobius diaperinus subjected to a UV treatment by a UV source having a UVB intensity (irradiance) of 190 μW/cm² at the powder for 45 minutes.

The sample S5″ (grey rectangle; N=2 for each duration; average±sd) corresponds to a powder of Tenebrio molitor subjected to a UV treatment having a UVB intensity (irradiance) of 120 μW/cm² for 45 minutes.

In this example, the treatment conditions for each of these samples S1″, S2″, S3″ and S4″ are identical:

Each of the UV sources is placed at 25 cm above the samples of powder.

The average temperature in the UV treatment room is 25° C.±1 with a relative humidity of 45%±5.

Here, IU is an international unit: 1 IU=0.025 μg of vitamin D3.

The measurements of the UVB intensity (irradiance) at the samples are measured using a UVB meter.

The analyses of vitamin D3 in these samples S1″, S2″, S3″, S4″ and S5″ were carried out by a Cofrac-certified independent laboratory according to the standard EN 12821: 2009-08 according to the reference method EN12822:2014.

In FIG. 3, it is observed that starting at 8 hours of UV treatment, an increase in the time of exposure to a UV source does not lead to a significant increase in the concentration of vitamin D3 in the beetle powder, whether for the first S1″ or the third S3″ samples.

Indeed, a plateau in the concentration of vitamin D3 is observed in this FIG. 3 starting at 8 hours of exposure.

During the first experiments carried out by the applicant, the plateau observed for the first sample appeared to correspond to the maximum attainable levels.

This plateau appeared to correspond to the processing of all of the 7-dehydrocholesterols contained in the matrix exposed to the UV rays into cholecalciferol.

Thus, a person skilled in the art according to their general knowledge could consider that the increase in the concentration of vitamin D3 was proportional to the increase in the light intensity and that, therefore, the increase in the intensity of the light source of the UVB rays would simply allow to reach the plateau in the concentration of vitamin D3 more rapidly.

However, this is not the case, and unexpectedly so.

Indeed, according to this same FIG. 3, it is observed that by increasing the irradiance by a factor of 3:
the maximum concentration obtained is increased by 5 for a given duration of exposure (for example: a vitamin D3 concentration of 352,400 IU/kg for the third sample S3″ of Tenebrio molitor versus a concentration of 70,000 IU/kg for the first sample S1″ of Tenebrio molitor, for the same duration of exposure of 8 hours to the UV treatment); and
the time necessary to reach a concentration of 20,000 IU/kg is reduced by a factor greater than 10: for example it takes the third sample S3″ of Tenebrio molitor 3.5 minutes of exposure to reach a concentration of 20,000 IU/kg of vitamin D3 versus a duration of exposure of 45 minutes for the first sample S1″.

The applicant thus observes that very high concentrations of vitamin D3 are reached very quickly, even with times of UVB exposure lower than 10 minutes: for example 26,000 IU/kg are reached after 5 minutes of exposure with a UV source having an irradiance of UVB rays of 190 μW/cm².

The comparison of the change over time in the concentration of vitamin D3 between the first S1″ and third S3″ samples (or between the second S2″ and fourth S4″ samples) shows that the above expected proportionality ratio between the time of exposure and the irradiance of the UVB rays is not encountered.

Consequently, the plateau of concentration of vitamin D3 observed in the first sample S1″ is not therefore caused by the complete processing of the sterols into cholecalciferol as put forward in the above hypothesis.

The results obtained during the present experiment thus show that by increasing the irradiance of the UVB rays, the increase in the concentration of vitamin D3 achieves unhoped-for performance that is much greater than the expected results: by increasing by a factor 3 the UVB irradiance on the processed beetle larvae, the maximum concentrations obtained are increased by a factor 5 and the time of exposure necessary to reach a given concentration is reduced by 10.

### 5^{th} SERIES OF TESTS

Ultraviolet (and in particular UVBs) is known for being an amplifier of the reaction of oxidation of food. In other words, significantly increasing the UVB irradiance on a beetle powder (even for short durations of exposure) must lead a priori to a significant amplification of the levels of oxidation of the fatty acids thereof until it is potentially made unsuitable for consumption.

In the food field, a powder must not therefore be irradiated with intensities that are too high to avoid degrading the beetle powder.

Nevertheless, the applicant carried out tests in the present case with a view to improving the performance of their method.

In this series of tests, the applicant thus tested the impact of a significant increase in the UVB irradiance and in the exposure time on the oxidation of the beetle powder.

During these tests, several oxidation indicators were measured like:
the peroxide value (PV). This value allows to evaluate the degree of oxidation of the unsaturated fatty acids of the fat. This value is an indicator of beginning of oxidation. Peroxides are formed from the free radicals that are created in the initiation phase of the oxidation reaction;
the anisidine value (AV). This value corresponds to the measurement of the secondary oxidation products of the fat. This value measures the quantity of aldehydes (mainly α, β-unsaturated aldehydes);
the TOTOX value (TOTal OXidation) which is a measurement of the oxidation of the oil on the basis of the peroxide value and the anisidine value. TOTOX value=(2×PV)+AV. A product is considered to be harmful if the TOTOX value is greater than 26.

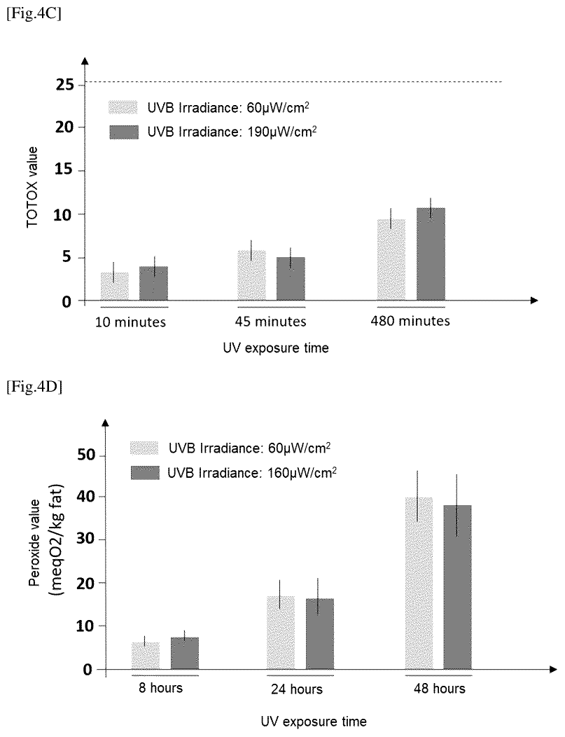

By varying the irradiance and the duration of exposure, the following results which are readable in FIGS. 4A to 4D are obtained at the end of these tests:

FIG. 4A shows the peroxide values of the powder of Tenebrio molitor having undergone a UV exposure with a UVB irradiance of 60 μW/cm² or of 190 μW/cm² for three distinct durations: 10, 45 or 480 minutes (N=2 for each duration; average±sd).

It is observed that the concentration of peroxide increased with the UV exposure time. However, for a given duration of exposure and in the testing conditions of the present invention, the level of irradiance does not affect the concentration of peroxide.

By increasing the level of UVB irradiance by 3, the concentration of peroxide remains similar for a given duration.

This constitutes a rather unexpected result.

FIG. 4B shows the anisidine values of the powder of Tenebrio molitor having undergone a UV exposure with a UVB irradiance of 60 μW/cm² or of 190 μW/cm² for three distinct durations: 10, 45 or 480 minutes (N=2 for each duration; average±sd).

During these tests, it is observed that neither the duration of exposure nor the level of irradiance affects this oxidation indicator.

FIG. 4C shows the TOTOX values of the powder of Tenebrio molitor having undergone a UV exposure with a UVB irradiance of 60 μW/cm² or of 190 μW/cm² for three distinct durations: 10, 45 or 480 minutes (N=2 for each duration; average±sd).

It is observed that up to 8 hours of UVB exposure, the values of the TOTOX value are below the threshold (dotted line in the drawing; TOTOX=26) usually used in the food industry.

FIG. 4D shows the change in the peroxide index of the beetle powder (Tenebrio molitor) for durations of exposure greater than or equal to 8 hours (N=2 for each duration; average±sd). It is observed that starting at 24 hours, the peroxide index starts to become critical. At 48 hours of exposure, the beetle powder is no longer edible because it is too oxidized, regardless of the level of UVB irradiance (60 or 190 μW/cm²).

It is noted that in these examples, the UVB sources are placed at 25 cm above the samples of powder. The average temperature in the UV treatment room is 25° C.±1 with a relative humidity of 45%±5.

The analyses of the peroxide value were carried out by a Cofrac-certified independent laboratory by the titration method. The analyses of the anisidine value were carried out by a Cofrac-certified independent laboratory by spectrophotometry.

All of the results obtained during the various experiments carried out are as unexpected as unhoped-for and allow to envisage very high gains in productivity.

Indeed, the present invention allows to achieve both:
a low exposure time (<10 minutes);
very high values of concentration of vitamin D3 (130,000 IU/kg of powder in 10 minutes with an irradiance of 190 μW/cm²);
a level of oxidation compliant with regulatory requirements.

All of this performance allows to confidently envisage a reliable and profitable industrialization of the method for UV treatment on processed beetle larvae of the present invention.

It must be observed that this detailed description relates to a specific exemplary embodiment of the present invention, but that in no case this description has any nature limiting to the object of the invention; indeed, on the contrary, the goal thereof is to eliminate any possible imprecision or any wrong interpretation of the claims that follow.

It must also be observed that the reference signs placed between parentheses in the claims that follow in no case have a limiting nature; the only goal of these signs is to improve the intelligibility and the comprehension of the claims that follow as well as the scope of the protection sought.

1. A method for preparing a beetle powder comprising:
a light treatment step during which at least one light source emits ultraviolet rays of at least the UVB type in the direction of beetle larvae, wherein the ultraviolet rays of the UVB type have an irradiance at the beetle powder greater than 80 μW/cm² and in that said beetle larvae are dehydrated at a temperature of between 40 and 250° C., preferably between 50 and 150° C., so that the slaughtered larvae have:
between 2 and 15% water, more preferably between 3 and 8% water, and/or
an activity of water (AW) of less than 0.7 and are optionally ground before said light treatment.

2. The method according to claim 1, wherein the irradiance of the UVB rays emitted is between 80 and 1,000 μW/cm².

3. The method according to claim 1, wherein the irradiance of the UVB rays emitted is preferably between 150 and 250 μW/cm2, preferably between 170 and 200 μW/cm2.

4. The method according to claim 1, wherein the processed larvae have a thickness of between 1 and 100 millimeters.

5. The method according to claim 4, wherein the processed larvae have a thickness of between 5 and 15 millimeters.

6. The method according to claim 1, wherein the ultraviolet rays emitted by said at least one light source in the direction of the beetle larvae during the light treatment step are:
of the UVB type and consist of electromagnetic radiation, the wavelength of which is between 280 nm and 320 nm, and/or
of the UVA type and consist of electromagnetic radiation, the wavelength of which is between 320 nm and 400 nm.

7. The method according to claim 1, wherein during the light treatment step, said at least one light source is positioned at a determined distance from the beetle larvae of between 1 and 100 centimeters, preferably between 5 and 20 centimeters.

8. The method according to claim 1, wherein during the light treatment step, said at least one light source emits the ultraviolet rays in the direction of the processed beetle larvae according to a treatment range of between 10 seconds and 24 hours.

9. The method according to claim 8, wherein the processing range is achieved continuously or cumulatively.

10. The method according to claim 1, wherein during all or part of the light treatment step, the processed beetle larvae are maintained in an environment having a substantially constant temperature of between 15 and 35° C., preferably between 22 and 26° C.

11. The method according to claim 1, wherein during all or part of the light treatment step, the processed beetle larvae are maintained in an environment having a substantially constant humidity of between 20 and 80% relative humidity.

12. The method according to claim 1, wherein the beetles are selected from the following species: Tenebrio molitor, Alphitobius diaperinus.

13. A beetle powder which can be obtained by the implementation of the preparation method according to claim 1, wherein it contains 130,000 IU/Kg of vitamin D3 and has a TOTOX oxidation index calculated from the PV peroxide value and the AV anisidine value such that the TOTOX oxidation index=(2×PV)+AV and is less than 26.

14. A use of a beetle powder according to claim 13 for human or animal food.

15. The use according to claim 14, wherein the powder is used as a dietary supplement.
